(19) United States
(12) Patent Application Publication
(10) Pub. No.: US 2009/0276706 A1
(43) Pub. Date: Nov. 5, 2009

(54) Method for automating troubleshooting flowcharts

(76) Inventor: Andrew Kenneth Lukes, Escondido, CA (US)

Correspondence Address: Andrew Lukes, 941 Ontario St., Escondido, CA, 92025, US

(21) Appl. No.: 12/151,311

(22) Filed: May 5, 2008

(51) Int. Cl. G06F 3/01

(52) U.S. Cl. 715/708

(57) ABSTRACT

A troubleshooting flowchart is automated by taking relevant information from the flowchart and entering it into a control file or database. A graphical user development tool is provided so a flowchart can be automated by someone not skilled in programming. Whenever possible the troubleshooting device queries the device under test, reads the response and determines the next troubleshooting step based on the response. If the troubleshooting step requires the user to provide an answer, the troubleshooting device displays a question, and a means to input the answer. Objects such as text, audio, video or other files are displayed to make the meaning of the question clearer. Also a troubleshooting step could be a procedure that the user needs to perform. Best troubleshooting practices can be implemented by unskilled users using this troubleshooting device.

### CROSS-REFERENCE TO RELATED APPLICATIONS

Not Applicable

### FEDERALLY SPONSORED RESEARCH

Not Applicable

### SEQUENCE LISTING OR PROGRAM

Source code is on the enclosed CDs

### BACKGROUND OF INVENTION

1. Field of the Invention

This invention relates to troubleshooting equipment and processes

2. Prior Art

When there is a problem with equipment or a process, it is difficult to quickly and accurately diagnose the malfunction unless a qualified technician is available on-site. If the equipment or process breaks down infrequently, it is uneconomical to have a technician waiting on-site for the next breakdown.

Typically a manufacturer or repair organization will send a technician on-site with all spare parts that could fix the problem. Taking all relevant spare parts is an expensive undertaking. When spare parts are out on one call, they can not be used for other calls. Also the bulk and weight of the parts can make transporting them difficult and expensive. Carrying all relevant parts can be difficult even when the technician can drive to a site. The problem is compounded when having to fly.

Taking only the most likely parts means that on a certain percentage of calls the technician will fail to get the equipment or process operational.

If no accurate troubleshooting can be done before the technician arrives, the equipment or process will not be usable until the technician arrives on-site and completes the repair. It can take a technician a day or two to get on-site if he or she has to fly. Even if he or she is ready to leave immediately, it could still take some time due to the length of the drive time to an airport, the lack of numerous flights throughout the day, (especially to small towns) and the drive to the site after landing. The technician may have to carry bulky, heavy parts on the flight, as well.

Often before a technician leaves, the technician or a help desk person will try to do preliminary troubleshooting with the end user to get the equipment or process working again, or failing that, determine which parts are needed so the technician will not have to carry so many spare parts. This process involves talking with an on-site person, unskilled in troubleshooting, to help with troubleshooting which can be difficult. It can be even more difficult if there is a bad phone connection, a language barrier, or loud background noise. Often troubleshooting is time consuming, error prone and tedious because the unskilled person has to be educated while troubleshooting to become effective.

Sometimes equipment and processes are customized so a standard service manual does not accurately cover the equipment on-site. Hours can be spent trying to determine exactly how the equipment was configured and customized. More time can be wasted if the support person troubleshoots assuming the equipment is one version when it is really another.

When equipment or processes from multiple vendors are combined to perform some task for a customer, often it is not clear to the user who should be called for service. If the user calls the repair organization responsible for part of the combination of equipment or processes, and the technician finds no trouble, the user may have to pay for an unneeded service call, and the repair has been delayed. The repair organization(s) responsible for the rest of the combined equipment or processes will have to be called and more waiting and downtime occurs.

What if the user calls all possible repair organizations and each says the problem is with the portion repaired by another organization? This method for automating troubleshooting flowcharts can help by providing a way for users to isolate the problem area themselves and then call the correct repair organization.

The organization using the equipment or process suffers from lost productivity due to slow repair times. If they do not meet contractual obligations due to the unscheduled down time, they may incur penalties, sometimes large ones.

People's time is poorly utilized. The on-site unskilled person has to be on the phone with a technician instead of doing his or her normal work. The technician has to spend extra time due to the low troubleshooting skill level of the on-site person. Spares inventory is higher than it should be since a lack of good preliminary troubleshooting means the technician must carry more spare parts on a call and that in turn means more inventory is required to deal with other calls.

Quick, accurate diagnosis before a technician is dispatched on-site will greatly reduce personnel and spare parts expenses. Shortened repair times gets the customer productive sooner.

Some operating systems come with help or repair steps, but they rely on the user to answer questions and do not directly check the operating system or other software for diagnosis information. Also, they tend to assume knowledge that many users do not have. A serious problem with current help or repair steps is that it takes a knowledgeable programmer to write them. Such a person is easy to find for software troubleshooting, but troubleshooting experts in other fields seldom have knowledge of software development. If they turned to an expert, they would have to face the time and expense it takes to have the software written. For modifications, they would have to go back to the software developer to have the changes implemented.

In U.S. Pat. No. 6,862,589 (2005) to Grant, it is assumed that a qualified technician is on-site. While the diagnostic tool can query the equipment under test, the technician has to determine the significance of the response and decide what to do next. Unskilled people can not do this properly.

While a skilled technician is aided by complete information, an unskilled person in a high stress situation, is better served by a very simple display with limited choices. It is better to have the troubleshooting software do as much work as possible and rely on the user only when necessary. The Grant patent has a user interface that an unskilled user would find complex and confusing.

The Grant patent does not deal effectively with highly customized equipment or equipment that can be extensively configured.

The solution is to automate troubleshooting flowcharts so that software queries the device under test and relies on a user for responses only when absolutely necessary. The software should be easily controlled and changed by someone who is a skilled troubleshooter, but has no software expertise.

### SUMMARY

In accordance with one embodiment a delimited file or database is created which contains information to control troubleshooting software to automate a troubleshooting flow chart. The information includes, but is not limited to such things as text strings to send to the device under test, expected results, values, and what the next step should be based on the result.

The software queries a device under test using a communications protocol such as, but not limited to TELNET. The software reads the response, searches for specific text or performs a comparison on a returned value to a predetermined value. Based on the results of the text search or value compare, the software selects the next troubleshooting step.

If the troubleshooting step does not lend itself to a query of the device, the troubleshooting software will display a user response form consisting of a question with a way for the user to select answers. Based on the user selected answer, the software will select the next step. When the user hits the go to next step button, the troubleshooting software will go to the next step.

The process repeats until the troubleshooting flowchart terminates.

The end user using the troubleshooting software can be skilled or unskilled. The person automating a troubleshooting flowchart uses a form to enter data into a delimited file or database and does not have to be skilled in computer programming.

The person automating a troubleshooting flowchart can insert objects like photographs, illustrations, text, video, audio or other types of files which will be displayed at the appropriate time. This allows for the troubleshooting software to be customized to the point where it could have unique pictures of a modified machine.

To create better troubleshooting flowcharts, a log file that tracks steps and machine responses is automatically generated. This file could also be used by a troubleshooting expert to help an end user.

A user can start the troubleshooting software. If monitoring or other software detects a malfunction, the troubleshooting software could be invoked by the monitoring software. The monitoring software can pass parameters to the troubleshooting software. Troubleshooting software A, could call troubleshooting software B. This would make it easier to write troubleshooting software modules that could be reused.

Sometimes a step might have to perform complicated tasks to determine the next step. The troubleshooting software can call a function or subroutine, pass parameters and get a response the determines the next step.

The troubleshooting software can pass parameters to other software if desired.

Enclosed CD Description

One embodiment of the disclosed invention is contained on the enclosed CDs. The software runs on windows XP service pack 2. It is written in visual basic 2005 express using .net version 2.

The following files are on the CD:

These files are accessed by the troubleshooting software

| C:\device>dir | | |
|---|---|---|
| Volume in drive C is HP_PAVILION | | |
| Volume Serial Number is D413-9356 | | |
| Directory of C:\device | | |
| 04/08/2008 08:03 PM | <DIR> | . |
| 04/08/2008 08:03 PM | <DIR> | .. |
| 04/08/2008 07:48 PM | <DIR> | machans |
| 04/08/2008 08:03 PM | <DIR> | sitespecific |
| 04/08/2008 08:03 PM | <DIR> | standard |
| 04/08/2008 07:44 PM | <DIR> | steps |
| 04/08/2008 08:03 PM | <DIR> | version |
| 0 File(s) | 0 bytes | |
| 7 Dir(s) 2,496,675,840 bytes free | | |
| C:\device\machans>dir | | |
| Volume in drive C is HP_PAVILION | | |
| Volume Serial Number is D413-9356 | | |
| Directory of C:\device\machans | | |
| 04/08/2008 07:48 PM | <DIR> | . |
| 04/08/2008 07:48 PM | <DIR> | .. |

| | |
|---|---|
| 04/08/2008 07:12 PM | 14 17.txt |
| 04/08/2008 07:04 PM | 52 21.txt |
| 04/08/2008 07:03 PM | 43 26.txt |
| 04/08/2008 07:19 PM | 20 5.txt |
| 04/08/2008 07:06 PM | 43 9.txt |

| 5 File(s) | 172 bytes | |
|---|---|---|
| 2 Dir(s) 2,496,966,656 bytes free | | |
| C:\device\sitespecific>dir | | |
| Volume in drive C is HP_PAVILION | | |
| Volume Serial Number is D413-9356 | | |
| Directory of C:\device\sitespecific | | |
| 04/08/2008 08:03 PM | <DIR> | . |
| 04/08/2008 08:03 PM | <DIR> | .. |
| 0 File(s) | 0 bytes | |
| 2 Dir(s) 2,496,696,320 bytes free | | |
| C:\device\standard>dir | | |
| Volume in drive C is HP_PAVILION | | |
| Volume Serial Number is D413-9356 | | |
| Directory of C:\device\standard | | |
| 04/08/2008 08:03 PM | <DIR> | . |
| 04/08/2008 08:03 PM | <DIR> | .. |

| | |
|---|---|
| 11/20/2007 07:40 PM | 1,173,691 1.ai |
| 11/19/2007 09:06 PM | 575,731 1.jpg |
| 11/19/2007 09:22 PM | 582,127 11.jpg |
| 11/19/2007 09:26 PM | 34 11.txt |
| 11/20/2007 07:47 PM | 1,169,737 110.ai |
| 11/20/2007 07:47 PM | 578,283 110.jpg |
| 11/20/2007 07:44 PM | 21 110.txt |
| 11/20/2007 07:25 PM | 1,170,470 112.ai |
| 11/20/2007 07:27 PM | 580,082 112.jpg |
| 11/20/2007 07:45 PM | 22 112.txt |
| 11/20/2007 07:33 PM | 1,168,501 116.ai |
| 11/20/2007 07:34 PM | 576,867 116.jpg |
| 11/20/2007 07:45 PM | 54 116.txt |
| 11/19/2007 09:08 PM | 577,203 12.jpg |
| 11/19/2007 09:27 PM | 26 12.txt |
| 11/19/2007 10:15 PM | 574,429 125.jpg |
| 11/19/2007 10:20 PM | 50 125.txt |
| 11/19/2007 10:15 PM | 1,165,025 126.ai |
| 11/19/2007 09:59 PM | 1,172,884 14.ai |
| 11/19/2007 10:00 PM | 574,468 14.jpg |
| 11/19/2007 09:55 PM | 15 14.txt |
| 11/19/2007 09:08 PM | 1,176,312 2.ai |
| 02/23/2008 04:04 PM | 583,887 21.jpg |
| 11/19/2007 09:26 PM | 17 21.txt |
| 11/19/2007 09:14 PM | 1,181,100 22.ai |
| 02/23/2008 04:00 PM | 583,971 22.jpg |
| 11/19/2007 09:27 PM | 21 22.txt |
| 11/19/2007 10:19 PM | 1,166,617 225.ai |
| 11/19/2007 10:19 PM | 574,019 225.jpg |
| 11/19/2007 10:22 PM | 54 225.txt |
| 11/19/2007 10:01 PM | 1,185,901 24.ai |
| 11/19/2007 10:11 PM | 585,019 24.jpg |
| 11/19/2007 10:23 PM | 49 24.txt |
| 06/13/2003 09:51 PM | 227,952 IMG7.jpg |
| 11/19/2007 09:24 PM | 583,349 junk12.jpg |
| 11/20/2007 07:26 PM | 580,082 step 12.jpg |
| 11/19/2007 09:12 PM | 1,176,010 Untitled-2.ai |

| 37 File(s) 21,244,080 bytes | | |
|---|---|---|
| 2 Dir(s) 2,496,696,320 bytes free | | |
| C:\device\steps>dir | | |
| Volume in drive C is HP_PAVILION | | |
| Volume Serial Number is D413-9356 | | |
| Directory of C:\device\steps | | |
| 04/08/2008 07:44 PM | <DIR> | . |
| 04/08/2008 07:44 PM | <DIR> | .. |

| | |
|---|---|
| 04/06/2008 07:38 PM | 23,377 steps.xml |

| 1 File(s) 23,377 bytes | | |
|---|---|---|
| 2 Dir(s) 2,496,696,320 bytes free | | |
| C:\device\version>dir | | |
| Volume in drive C is HP_PAVILION | | |
| Volume Serial Number is D413-9356 | | |
| Directory of C:\device\version | | |
| 04/08/2008 08:03 PM | <DIR> | . |
| 04/08/2008 08:03 PM | <DIR> | .. |

| | |
|---|---|
| 06/13/2003 09:51 PM | 1,538,506 IMG4.JPG |

```
        1 File(s)  1,538,506 bytes
        2 Dir(s) 2,496,606,208 bytes free
```

### DRAWINGS—FIGURES

FIG. 1 shows the troubleshooting steps to be automated

FIG. 2 shows part of the control XML file that contains information used by the troubleshooting software

FIG. 3 shows the input form to create a control file

FIG. 4 shows a user response form

FIG. 5 shows a machine response form

FIG. 6 shows an overview of the software

### DRAWINGS—REFERENCE NUMERALS

202 XML file
204 step stepum attribute
206 element step_title
208 element user_comment
210 element user_question
212 element machine_command
214 element machine_wait_time
216 element compare_integeryes
218 element compare_type_equality
220 element compare_to_text
222 element compare_to_integer
224 element yes_ans_next_step
226 element no_ans_next_step
228 element always_next_step
230 element isuserresponse
232 element isnextyesno
234 element pause_for_next_step
236 element beforematch
238 element aftermatch
240 element timer_expired_step
242 element function-sub
244 element parameters
302 current step text box
304 delete true/yes next step check box
306 true/yes next step text box
308 delete false/no next step check box
310 false/no next step text box
312 delete always next step check box
314 always next step text box
316 step type container
318 user comments or machine command text box
319 user comments or machine command label
320 answer type container
322 machine wait time text box
323 machine response time out step text box
324 selected text text box
325 delete machine response time out step check box
326 comparison type container
328 pause time until next step
330 delete step button
332 step text box
334 add step button
335 time out step button
336 current step button
338 true next step button
340 false next step button
342 always next step button
344 steps list
345 user question or machine response label
346 user question or machine response text box
347 before button
348 text selection button
349 after button
350 compare to this text or number text box
352 comparison operator container
354 enter button
356 true/yes false/no answer button
358 always next step button
360 user response button
362 machine response button
364 campare text button
366 compare number button
368 equals button
370 greater than button
372 less than button
374 greater than or equal to button
376 less than or equal to button
402 current step number text box
404 step title text box
406 comments for user text box
408 yes/no container
410 go to next step button
412 question for user text box
414 object label left side
416 object label right side
418 object container left side
420 object container right side
422 yes button
424 no button
502 current step number
504 step title text box
506 machine command text box
508 yes/no container
510 next step button
512 machine response text box
514 result text box
516 equality text box
518 compare to text box
520 yes button
522 no button
602 manual start symbol
604 automatic start symbol
606 troubleshooting software
608 subroutine
610 function
612 troubleshooting software terminates stop symbol
614 invoke other software and stop symbol

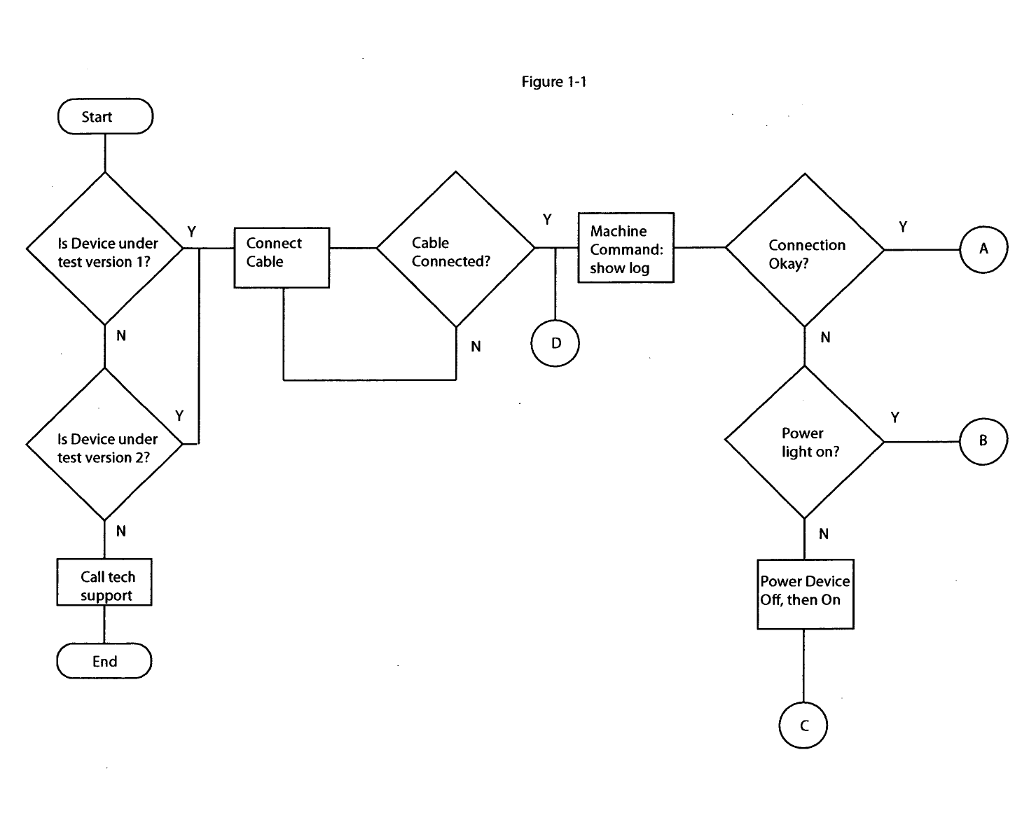

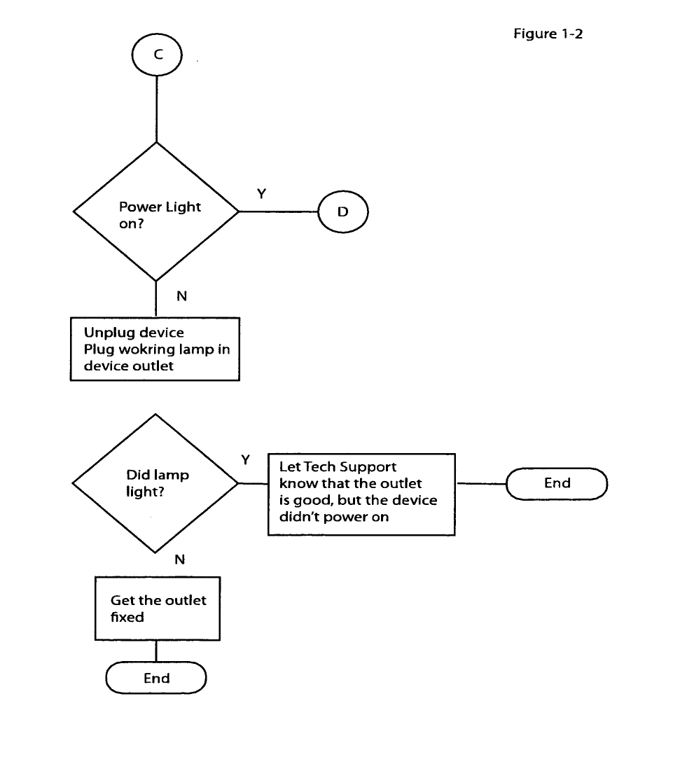

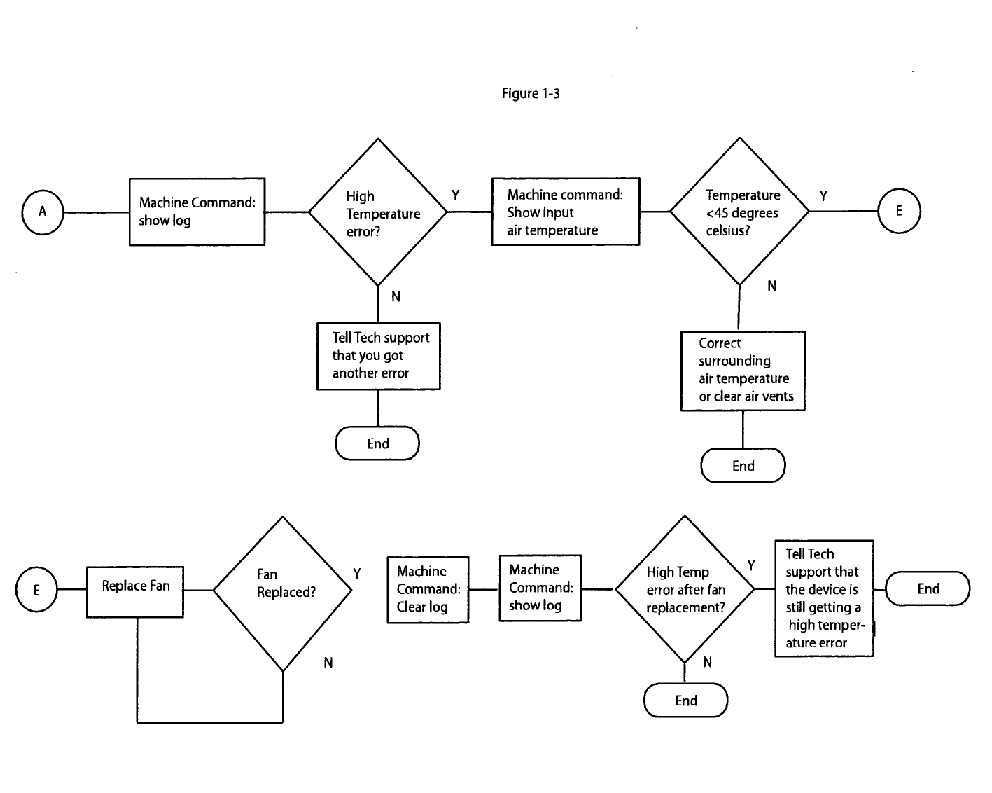

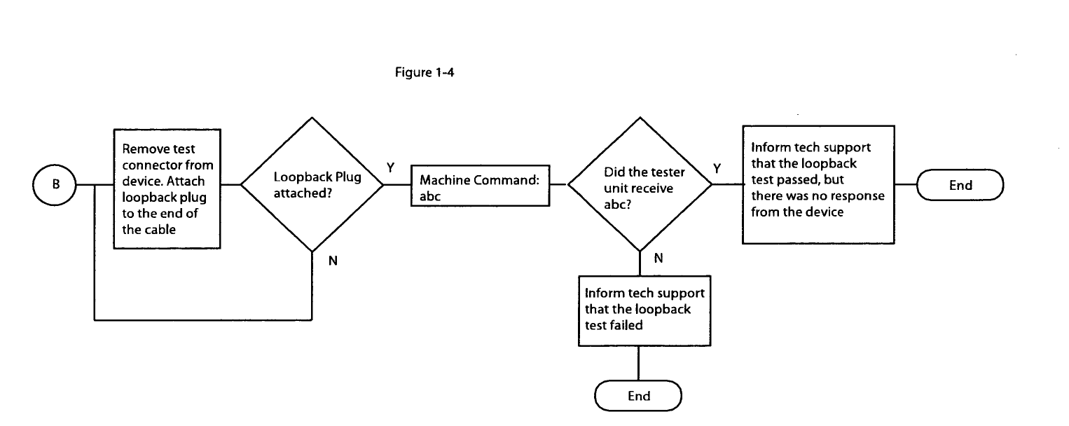

### DETAILED DESCRIPTION—FIGURE 1, 2, 3, 4, 5, 6

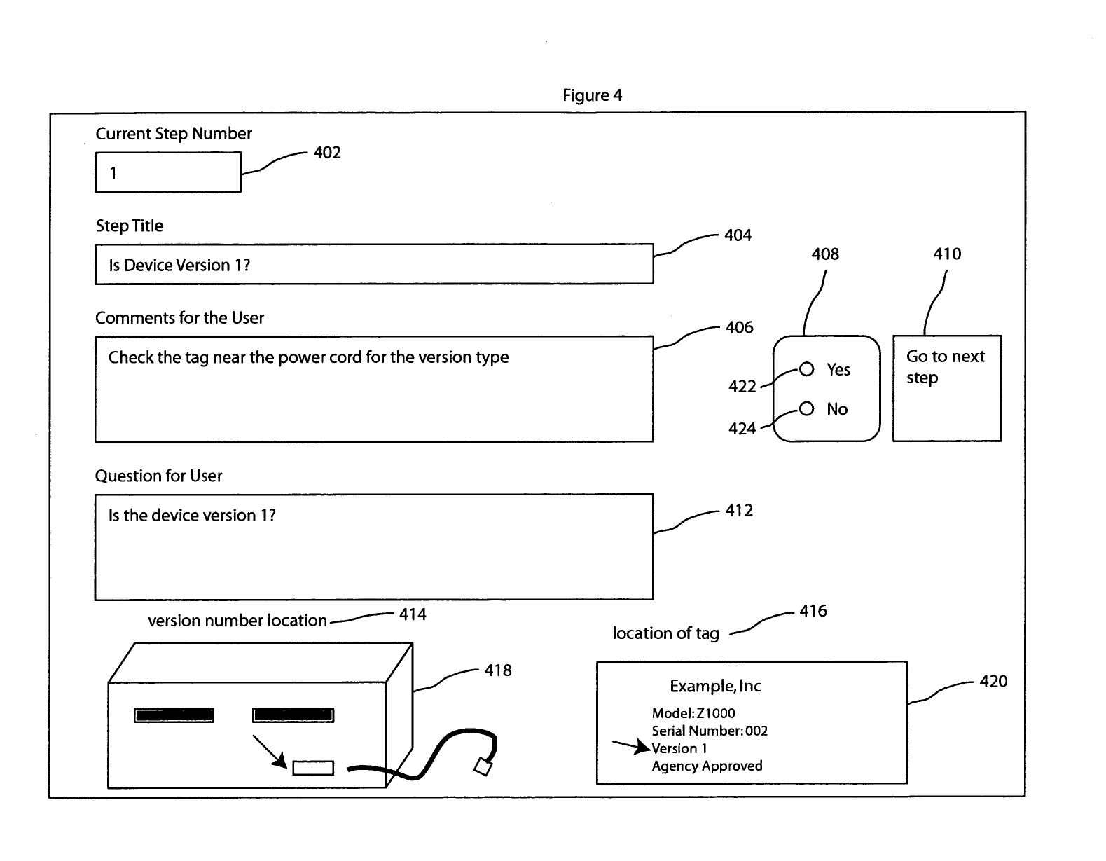

An exemplary embodiment of the method to automate troubleshooting flowcharts for use by unskilled people designed by skilled troubleshooters who are not skilled at software is illustrated in FIGS. 1, 2, 3, 4, 5 and 6. In this embodiment we will use an XML file for the control file, although other types of files or databases will work as well.

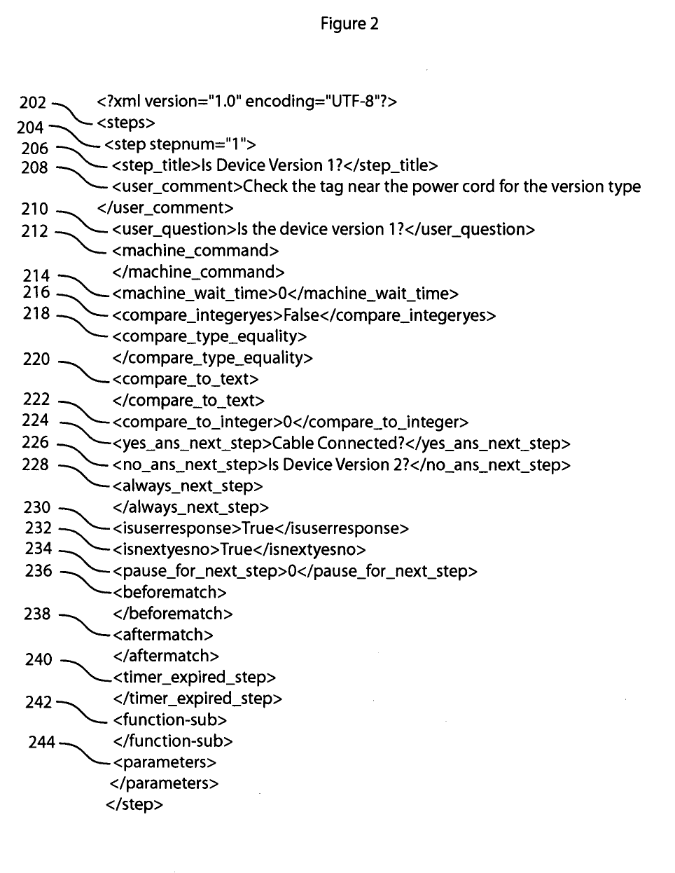

In FIG. 2, one step is shown. Multiple steps would be stored in the following format.

```
Control File Format
<steps>
    <step stepnum = “1”>
        <element1>
        <element2>
        <element3>
        and so on
    <step stepnum = “2”>
        <element1>
        <element2>
        <element3>
        and so on
    <step stepnum = “3’> and so on
</steps>
```

This format keeps step information together with the correct step. It allows for easy searching due to the same format. Any number of steps can be created easily.

### Creating the Control File or Database

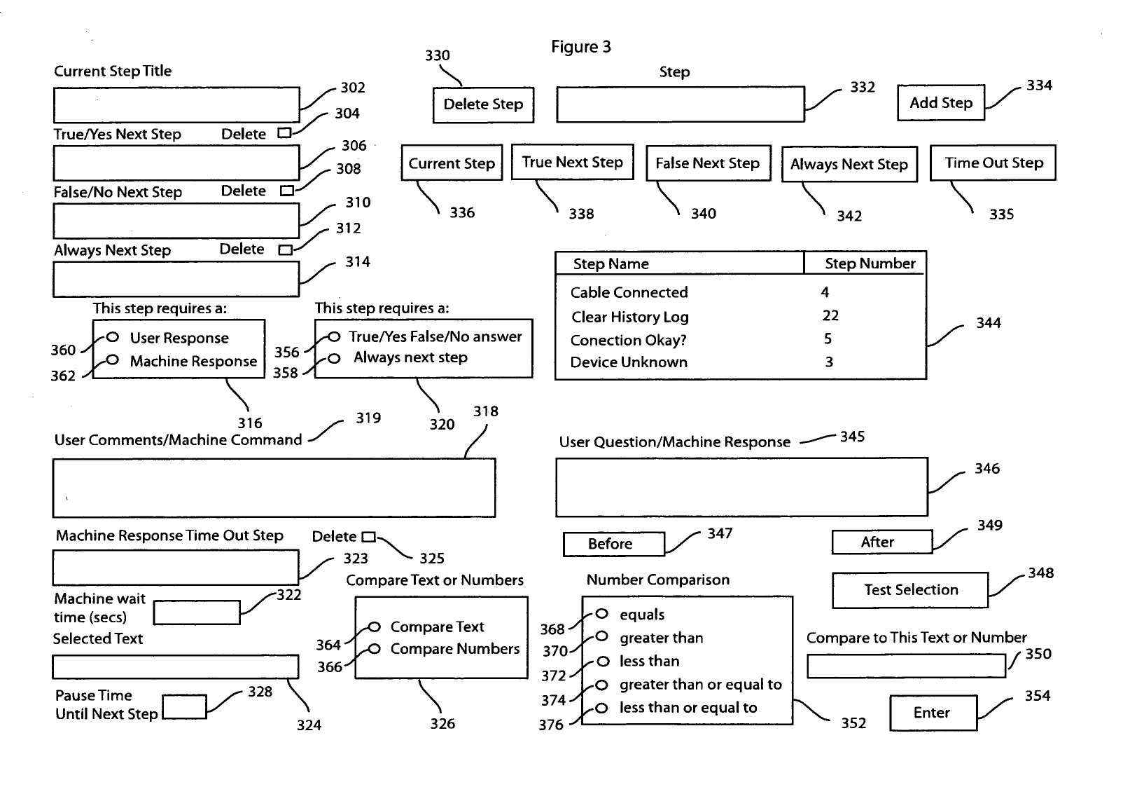

After a skilled troubleshooter has planned troubleshooting steps, for example those shown in FIG. 1, he or she needs to create the control file or database to direct the troubleshooting software. The data entry form shown in FIG. 3 is used to create the control file or database.

The person automating the troubleshooting flowchart enters the flowchart step title in text box 332. He or she adds the step by clicking on the add step button 334. The software used to create the control file (which hereinafter will be called the generating software) writes the title to the list box 344. Also the generating software creates a new parent step 204 in the control file 202, populates the stepnum attribute with a unique step number, and copies the contents of text box 332 into element step_title 206. A step title can be added at one time or as needed while creating the control file or database.

Once a step is displayed in the list box 344 it can be selected and placed in the appropriate text box. Selecting a step in the list box 344 and clicking on the current step button 336 will cause the step title to appear in current step title text box 302.

If the user selects true/yes False/No answer button 356 located in container 320, then the text boxes 306, and 310, the delete check boxes 304 and 308, along with the corresponding labels are enabled and selecting a step in the list box and clicking on the true next step button 338 will cause the step title to appear in the true/yes next step text box 306. Selecting a step in the list box 344 and clicking on the false next step button 340 will cause the step title to appear in the false next step text box 310.

If the user selects always next step button 358 located in container 320, the text box 314 is enabled along with the delete check box 312 and related labels. Selecting a step in the list box 344 and clicking on the always next step button 342 will cause the step title to appear in the always next step text box 314.

Selecting a step in list box 344 and clicking the timeout step button 335 will cause the step title to appear in the timeout step text box 323.

The delete check boxes 304, 308, 312 and 325 will clear the contents of text boxes 306, 310, 314 and 323 respectively.

When the user selects a step in the list box 344 and clicks the delete step button 330 the associated parent element is deleted and the contents of elements yes_ans_next step 224, no_ans_next_step 226, always_next_step 228, and timer_expired_step 240 in all parent elements are checked to see if they contain the same step title. If they do, the contents of the previously mentioned elements are cleared.

There are two main types of steps. By selecting the user response button 360 in container 316, text box 318 and 346 are enabled and user comments and the user question can be entered respectively. Label 319 displays User Comments and label 345 displays User Question.

By selecting machine response button 362 in container 316, label 319 displays machine command and label 345 displays machine response. The user enters the machine command in text box 318. A typical response to the command is entered in text box 346. Text boxes 322, 324, 328 and 350 are enabled. Container 326 is enabled as well as its contents.

If the step requires that a number in the machine response be compared to a value, the user selects compare numbers button 366 in container 326. This causes the container 352 and its contents to be enabled. The user selects one of the number comparison buttons, namely, equals 368, greater than 370, less than 372, greater than or equal to 374, or less than or equal to 376.

Once the machine response is entered into text box 346, the user selects the text after the machine prompt and before the number of interest and clicks the before button 347, which copies the selected text to file element beforematch 236. The user selects all of the text after the number of interest and clicks the after button 349, which copies the text to file element after match 238. The software performs a match on the text string in text box 346 with the beforematch string. When the match is found it deletes matching text and all text to the left of the match to the beginning of the text string. This method is necessary because often machine prompts vary from one machine to another to denote the location of the machine or some other useful information. If a match was done from the beginning of the text string in text box 346 to the number of interest, it would seldom if ever match since the prompts would vary from machine to machine. The text in text box 346 is searched for a match to the aftermatch string. When the match is found all matching text is deleted. To verify that the user selected what he or she really wanted, the number left after all unwanted text is deleted is displayed in text box 324.

If the user wants to see if the text from the equipment under test matches predetermined text, the user selects compare text button 364 in container 326. The desired text is entered into text box 350. Clicking button test selection 348 will search the machine response text in text box 346 and if there is a match, the match is displayed in selected text box 324.

It is possible that the equipment under test will not respond to a command. The software will wait for the time entered in text box 322, then will go to the timeout step entered in text box 323.

Some commands will respond immediately, but will start something in the background that takes a while to run. For example a command might reset some part of the equipment under test. It will immediately respond with an okay message, but the actual resetting will take a few seconds. If the software immediately checks the status of the part being reset, the results might not be accurate and useful. The pause time until next step 328 allows the person automating a troubleshooting flowchart to specify how long to wait until the next step executes.

Once the user has completed data entry for a step and clicks the enter button 354, the generating software copies the contents of text boxes to the appropriate elements in the selected step. The states of the radio buttons are also recorded.

The contents of true/yes next step text box 306 will be copied to element yes_ans_next_step 224. The contents of false/no next step text box 310 will be copied to element no_ans_next_step 226.

The contents of always next step text box 314 will be copied to element always_next_step 228.

If user response button 360 is selected in container 316, the user comments text box 318 will be copied to element user_comment 208. If machine response button 362 is selected in container 316, the contents of text box 318 now labeled machine command will be copied to element machine command 212. If user response button 360 is selected in container 316, the contents of user question or machine response text box 346 are copied to element user_question 210. If compare text button 364 is selected in container 326, the contents of text box 350 is copied to element compare_to_text 220. If compare number button 366 is selected in container 326, the before and after text created by clicking test selection button 348 is copied to elements beforematch 236 and aftermatch 238 respectively. The contents of machine wait time text box 322 will be copied to element machine_wait_time 214. The contents of pause time until next step text box 328 is copied to element pause_for_next step 234. The selection of user response button 360 in container 316 causes the boolean state true to be recorded in element isuserresponse 230. The selection of machine response button 362 in container 316 causes the boolean state false to be recorded in element isuserresponse 230. The selection of the true/yes false/no button 356 in container 320 causes the boolean state true to be recorded in element isnextyesno 232. The selection of always next step button 358 in container 320 causes the boolean state false to be recorded in element isnextyesno 232. The type of comparison selected in container 326 is recorded in element compare_integeryes 216. If compare text button 364 is selected in container 326, then the contents of compare to this text or number text box 350 is copied to element compare_to_text 220. If compare numbers button 366 is selected in container 326, the type of equality selected in container 352 is written to element compare_type_equality 218. If equals button 368 is selected then eq is entered in element compare_type_equality 218. If greater than button 370 is selected then gt is entered in element compare_type_equality 218. If less than button 372 is selected then It is entered in element compare_type_equality 218. If greater than or equal to button 374 is selected then gteq is entered in elementcompare_type_equality 218. If less than or equal to button 374 is selected then lteq is entered in element compare_type_equality 218. The contents of text box 350 is copied to element compare_to_integer 222.

After the step is saved the user can quit out of the application or continue by selecting a new step in the step list box 344 and repeating the process. The user can go back and make changes to previously entered steps if necessary.

When the user is finished, the control file will have all of the information required to run the troubleshooting program which is uniquely designed for a given piece of equipment or process.

### Running the Troubleshooting Software

The troubleshooting software and control file are loaded on a test PC or laptop. When the software is invoked, it reads the first step in the control file and displays the appropriate information. The software starts a log file that tracks steps and machine responses so the troubleshooting session can be saved and analyzed later, along with other sessions to look for trends or ways to improve the troubleshooting steps.

### User Response Step

If the selected step is a user response step, then step attribute 204 is displayed in the current step number text box 402. Step title element 206 is displayed in the step title text box 404. User_comment element 208 is displayed in comments for user text box 406. User_question 210 is displayed in the question for user text box 412. Container 408 is enabled along with its contents yes button 422 and no button 424.

The objects labeled 414, 416, 418 and 420 can be located in three directories called generic, version or site specific. The software checks the directories in this order: site specific, version and generic. Once the software finds the required file it stops looking further and displays the file in the appropriate field. This ensures that the best information is displayed for a given piece of equipment.

The text for the left object label is displayed above the object on object label left side 414. The text for the right object label is displayed above the object on object label right side 416. In object container left side 418 and object container right side 420, an object such as a text, audio, video, picture or other type of file is displayed.

The user reads the comments, questions, picture labels and looks at the pictures to determine how to answer the question. Once the user knows the answer, the user selects the yes button 422 or no button 424 and clicks the go to next step button 410. If the user selected yes, the software goes to the step identified by element yes_ans_next_step 224 in the current step. If the user selected no, the software goes to the step identified by element no_ans_next_step 226 in the current step. The software reads the elements of the selected step and displays a user response form or a machine response form as directed by the control file. The process repeats until a step terminates the process.

### Machine Response Step

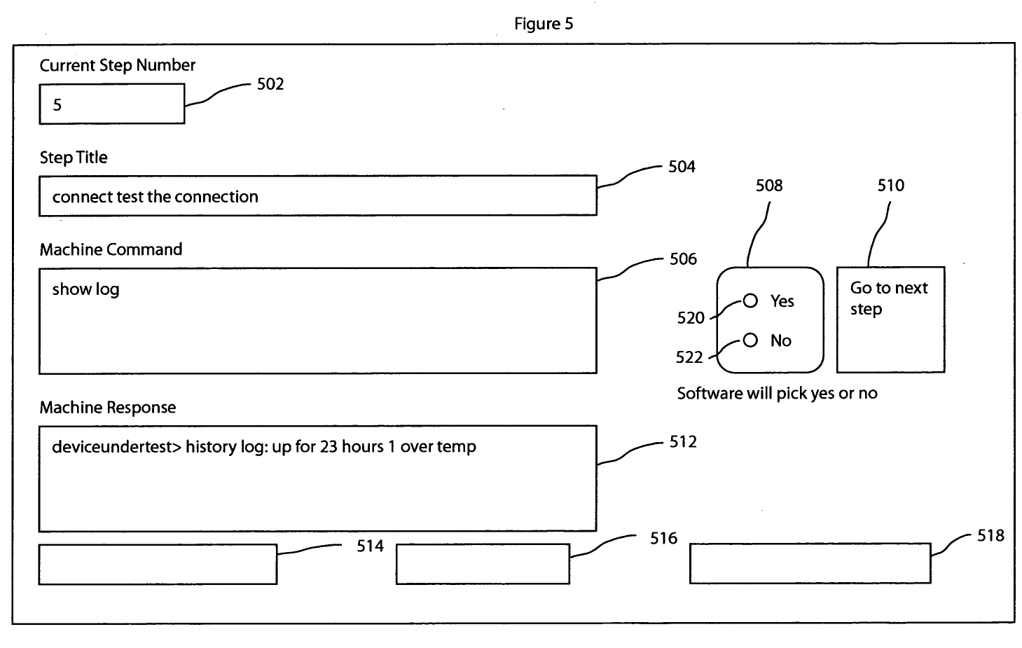

A step that communicates with the equipment under test is shown in FIG. 5. Container 508 is disabled along with its contents yes button 520 and no button 522. This prevents user confusion. Control file attribute step stepnum 204 is displayed in current step number 502. Element step_title 206 is displayed in the step title text box 504. Element machine_command 212 is displayed in machine command text box 506 and is sent over a communications link to the machine under test using commonly known protocols such as TELNET, SSH, HTTP, HTTPS, SNMP or other communication protocols. The machine response is received from the equipment under test and is displayed in machine response text box 512. If the element compare_integeryes 216 is true, then the elements beforematch 236 and aftermatch 238 are used to remove everything but the number of interest as described earlier in the control file machine step creation description. The resulting number is displayed in result text box 514. The element compare_type_equality 218 is displayed in equality text box 516. The element compare_to_integer 222 is displayed in compare to text box 518. The software performs the comparison and selects yes or no based on the comparison result. Once the software selects the answer, the user clicks the go to next step button 510. If yes button 520 is selected, the software goes to the step identified by the element yes_ans_next_step 224 in the current step. If no button 522 is selected, the software goes to the step identified by the element no_ans_next_step 226. The software reads the elements of the selected step and displays a user response form or a machine response form as directed by the control file. The process repeats until a step terminates the process.

If element compare_integeryes 216 is false, then match found? is displayed in text box 516. Element compare_to_text 220 is displayed in text box 518. The software performs searches for match of the compare_to_text 220 within the machine response, and selects yes or no based on the comparison result. Once the software selects the answer, the user clicks the go to next step button 510. If yes is selected, the software goes to the step identified by element yes_ans_next_step 224. If no is selected, the software goes to the step identified by element no_ans_next_step 226. The software reads the elements of the selected step and displays a user response form or a machine response form as directed by the control file. The process repeats until a step terminates the process.

For both user response and machine response steps, step element isnextyesno 232 is checked. If it is true, then the next step process proceeds as outlined above. However sometimes the next step will always be the same one. In that case the isnextyesno 232 will be false. Clicking the next step button 410 or 510 will always cause the software to go to the step in element always_next_step 228.

When a new step is selected, the machine wait timer is loaded with the time from machine_wait_time 214 and starts to count down. If the timer expires, the software will go to the timer_expired_step 240. If the equipment under test responds before the timer expires, normal operation occurs.

When a new step is selected, the wait for next step timer is loaded with the time from the pause_for_next_step 234 and starts to count down. When the timer expires, the go to next step button 410 or 510 is enabled.

The process continues until the troubleshooting flowchart terminates.

### Other Features

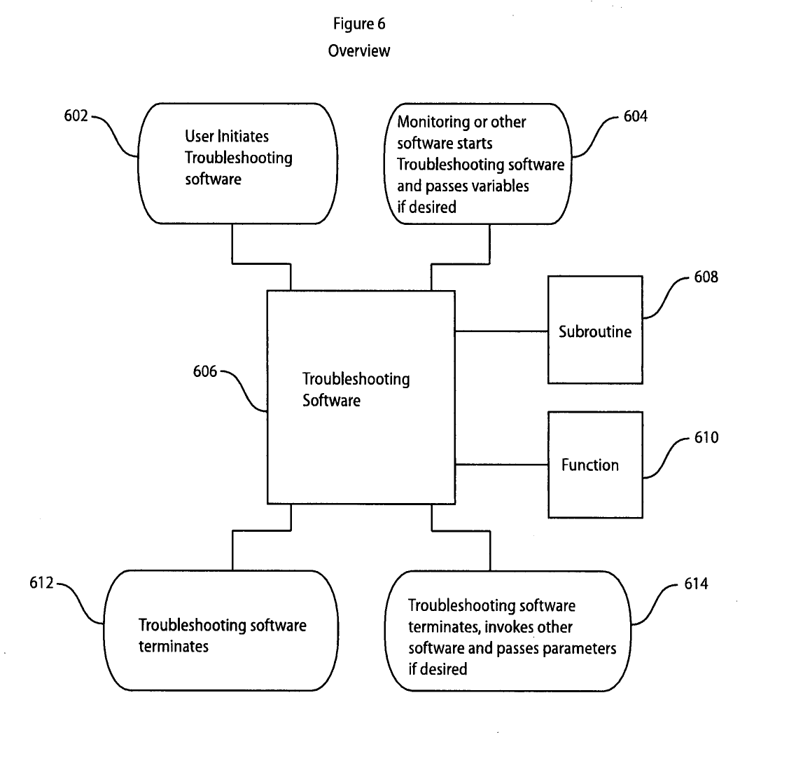

The troubleshooting software can be manually started as shown in FIG. 6, manual start symbol 602. Automatic start symbol 604 shows that the troubleshooting software can be invoked by other software, such as monitoring software. The monitoring software may have already located the problem, and so can pass parameters that will guide the troubleshooting software 606. There might be instances where simple compares aren't good enough. Suppose you wanted to know how fast error counters were incrementing. A function 610 could be used to capture error counters at time 1 and then again at time 2, subtract time 1 from time 2 and determine the error rate over the time interval. Subroutine 608 could be used to perform tasks that don't require returned information. There could be many subroutines and functions that are called by the troubleshooting software which looks at the XML file child element function-sub 242, along with the element parameters 244 to determine what function or subroutine to call along with what parameters to pass if any.

Before the troubleshooting software terminates, it could pass on information to other software as shown in invoke other software and stop symbol 614 or it could simply terminate as shown in troubleshooting software terminates stop symbol 612.

### Advantages

When possible, the software queries the machine so the on-site person doesn't have to provide input. The combination of clear simple steps with pictures, audio and video to help explain the step, make an unskilled on-site person an effective troubleshooter. The on-site person will be able to perform simple repairs and help a technician accurately determine what spare parts are needed. If multiple repair organizations are involved, the on site person will be able to do preliminary troubleshooting to determine which organization to call. Down time is minimized for the end user, and the end user and repair companies will all save money and time.

The troubleshooting steps can be easily customized simply by changing the control file. Compare that to writing software with troubleshooting steps built in. Every version would require a software rewrite and it would be difficult to maintain the versions. Again time and money are saved.

If a site is unique in some way the installing technician can take pictures and video of the equipment which can be easily added to the appropriate troubleshooting steps. This ensures that the end user won't be confused by almost, but not quite accurate pictures and information. The repair process will be more accurate and quicker.

If a skilled troubleshooter wishes to follow along as an unskilled person goes through the troubleshooting process, the skilled troubleshooter can turn off the answer selection for machine questions. He or she can then ask the on-site person which step was selected, and select the same step. In that way the skilled troubleshooter will experience what the end user does.

The troubleshooting software can be loaded onto a PC, Laptop or PDA at the time of install where it will remain until needed. There is no requirement for a network connection to a repository to download the troubleshooting steps at the time of failure. However, if the user doesn't have the software, it could be downloaded from another machine locally or remotely.

The end user can run the troubleshooting software anytime day or night so he or she doesn't need to wait for a help desk person to attempt to troubleshoot and possibly perform simple repair tasks.

### Conclusions, Ramifications and Scope

Although the description contains many specificities, these should not be construed as limiting the scope of the embodiment.

The concept of creating and storing troubleshooting steps can work with data storage and retrieval methods such as XML, databases, flat files or other data storage methods.

There can be additional types of steps such as a step that checks for one of several possible responses or text strings within a response and goes to one of several identified next steps. Another type of step might call a built in subroutine or function when the step is entered, exited or when an event occurs. For example, the troubleshooting software could deal with a spares database, and a database with relevant information relating to repairs like contact information, maintenance schedules, warranty and maintenance agreement information. The application to access this information could be made available on the menu or launched from a step.

In some applications it might be necessary to store information obtained in one step and use it in another. The software can have storage space for that purpose.

It doesn't matter where the software is run. It might be run at a remote site, on a local PC, PDA or laptop, or built into the equipment that needs troubleshooting.

The troubleshooting software could be invoked by monitoring software or some other application. Parameters could be passed by an XML file designed for that purpose, or some other means. Control files could be daisy chained to reuse common control functions. The troubleshooting software could pass on parameters to another copy of troubleshooting software or other applications. These additional features and concepts are well known to software developers and can be readily designed by someone skilled in the art of software development.

The scope of the embodiment should be determined by the appended claims and their legal equivalents, rather than by examples given.

1. A method for automating a troubleshooting flowchart comprising:
A) providing a control file or database containing information for a plurality of steps of said troubleshooting flowchart
B) providing a troubleshooting procedure which will read said control file or database and using information obtained from said control file or database will,
a) query a device under test,
b) read a response from said device, search for predetermined text in said response, or perform a comparison on a returned value in said response to a predetermined value,
c) under the control of said control file or database select the next step in said troubleshooting flowchart based on the results of said text search or said comparison, or
d) if a step doesn't lend itself to a query of said device, display a user response form consisting of a question for a user to answer with a plurality of selectable responses,
e) under the control of said control file or database select the next step in said flowchart based on which response said user selected
e) repeat a) through c) or d) through e) until said flowchart terminates.

2. The method of claim 1 wherein photographs, illustrations, text, video, audio or other types of objects are inserted into said user response form to customize information.

3. The method of claim 1 wherein a log file that tracks steps and machine and user responses is automatically generated.

4. The method of claim 1 wherein said method can be started manually or automatically by software which can pass parameters if desired.

5. The method of claim 1 wherein said troubleshooting procedure can invoke a subroutine, function and/or other software and pass parameters if desired.

6. The method of claim 1 wherein said control file or database is generated by control file or database generation software.

7. An apparatus for automating troubleshooting flowcharts comprising:
A) a control file or database consisting of troubleshooting step information derived from said troubleshooting flowchart,
B) a diagnostic apparatus controlled by said control file or database which has input and output devices for user interaction and an input and output device to interact with a device under test,
C) said diagnostic apparatus,
a) queries said device under test using said input and output device to interact with said device under test,
b) reads the response from said device, searches for predetermined text in said response, or performs a comparison on a returned value in said response to a predetermined value,
c) under the control of said control file or database selects the next step in said flowchart based on the results of said text search or said comparison, or
d) if said next step doesn't lend itself to a query of said device, displays a user response form on said output device for user interaction consisting of a question for the user to answer with a plurality of selectable responses selected by using said input device for users,
e) under the control of said control file or database selects the next step in said flowchart based on which response said user selected
f) repeat a) through c) or d) through e)until said flowchart terminates.

8. The apparatus of claim 7 wherein photographs, illustrations, text, video, audio or other types of objects are inserted into said user response form to customize information.

9. The apparatus of claim 7 wherein a log file that tracks steps and machine responses is automatically generated.

10. The apparatus of claim 7 wherein said apparatus can be started manually or automatically by software which can pass parameters if desired.

11. The apparatus of claim 7 wherein said troubleshooting procedure can invoke a subroutine, function and/or other software and pass parameters if desired.

12. The apparatus of claim 7 wherein said control file or database is generated by control file or database generation software.
